(19) United States
(12) Patent Application Publication
(10) Pub. No.: US 2008/0233332 A1
(43) Pub. Date: Sep. 25, 2008

(54) Thermal Insulation Material

(75) Inventor: Alan Burgess, Liverpool (GB)

Correspondence Address: ROTHWELL, FIGG, ERNST & MANBECK, P.C., 1425 K STREET, N.W., SUITE 800, WASHINGTON, DC, 20005, US

(73) Assignee: CRP Group Limited, Skelmersdale (GB)

(21) Appl. No.: 10/571,595

(22) PCT Filed: Aug. 6, 2004
(86) PCT No.: PCT/GB2004/003392

§ 371 Date: Jan. 16, 2007

(30) Foreign Application Priority Data
Sep. 12, 2003 (GB) 0321406.1

(51) Int. Cl. B32B 3/00; B29C 45/00

(52) U.S. Cl. 428/71; 264/279.1

(57) ABSTRACT

A thermal insulation material, and a method for its manufacture, in which the material is suited to underwater use. The material includes a matrix 20 of cured polymer material, most preferably polyurethane, in which are embedded insulation bodies 10 each including a core 12 of foamed material and an outer structural plastics layer 14. The materials and the manufacturing conditions are chosen such that temperatures within the low density bodies during manufacture are not sufficient to destroy the foamed cores. The result is a material with excellent thermal insulation properties

The present invention relates to a thermal insulation material for use underwater and to insulating claddings for use underwater.

While the present invention has numerous other potential applications, it is particularly well suited to use in cladding underwater pipe assemblies such as those used for conveying oil, gas, condensate and other fluids to/from a wellhead.

When hydrocarbons and/or other fluids are extracted from an underwater wellhead, it is necessary to convey the fluids to a production platform for distribution to, for example, a tanker or into a further oil pipeline for onward transmission. This is normally achieved by means of a riser which extends between the production platform and the seabed and a flowline connecting the lower end of the riser to the wellhead.

The hydrocarbons and/or other fluids emerge from the wellhead at an elevated temperature. It is important to maintain the fluids within the flowline and riser at an elevated temperature since an excessive drop in temperature causes components to solidify, resulting in blockage of the conduit and loss of production, and requiring expensive treatment to rectify the problem. This can be a significant problem since flowlines can be of a considerable length (of the order of 30 km) and they often pass through water which is only a few degrees above freezing point. Thus, unless the pipe is insulated along its length the heat loss from the pipe may result in pipe blockage.

One solution is to use a “pipe-in-pipe” system in which the fluid flows through an inner pipe which is itself located within a larger outer pipe, heated liquid being passed into the annular space between the two pipes in order to keep the fluid at an elevated temperature. However, this can be a problem for very lengthy flowlines, since the heating fluid itself tends to lose a great deal of heat.

An alternative is to utilise passive insulation techniques in which the carrying pipe is clad with an insulating material which maintains the contents at a sufficiently high temperature to prevent solidification or waxing of its components. Materials used for such insulation need to be capable of surviving hydrostatic pressure from the surrounding water and in deep sea hydrocarbon extraction this pressure can be large. Clearly the insulation material should also have low thermal conductivity.

It is known to use syntactic foam to provide insulation underwater. This has a matrix of moulded plastics in which are small elements commonly referred to as “microspheres”. In some cases the foam also incorporates “macrospheres”, the latter being larger than the former. A known type of macrosphere is made by coating expanded polystyrene cores with a reinforced, thermosetting plastics material such as epoxy. The resulting reinforced epoxy shell of the macrosphere serves to withstand hydrostatic pressure in use. The smaller microspheres typically comprise hollow glass beads. A conventional type of syntactic foam uses both micro and macrospheres in an epoxy matrix.

Minimising thermal conductivity of the material is of course crucial where it is used for insulation. In this regard a problem has now been recognised in the existing material. Curing of the plastics matrix is typically an exothermic process and indeed epoxy mouldings are normally heated, at least at the beginning of curing. In the known materials the consequent elevated temperature causes the expanded polystyrene core of the macrospheres to be destroyed. The polystyrene returns to an un-expanded state and, when a sample is cut open, is observed to form a small body at the bottom of the macrosphere interior, the remainder of the sphere then being hollow and gas filled. Consequently convection and conduction taking place within the macrosphere serve to increase the thermal conductivity of the material as a whole.

By way of technical background, reference is directed to certain published patents and applications known to the applicant:—

i. published international patent application WO 02/075203 (CRP Group Ltd) discloses an insulating cladding having solid pellets of polypropylene dispersed within a plastics matrix;

ii. U.S. Pat. No. 4,744,842 (Webster et al) is concerned with a thermally insulating coating for a pipeline which, it is suggested, may contain clusters of “cells” of foamed material. The foaming process is said to create a continuous skin of the same material used for the foam, a process commonly known as “self skinning”. It is believed that such foam cells would be incapable of withstanding large hydrostatic pressures;

iii. published European patent application EP 1070906 concerns insulation material containing “beads” and we are told that these can be either solid or hollow;

iv. published patent application WO 99/05447 (Curning Corporation) describes a pipeline insulated with material of the type described above, containing hollow macrospheres; and

v. published UK patent application GB20009181 again concerns a material containing hollow bodies.

In accordance with a first aspect of the present invention, there is a method of manufacturing thermal insulation for underwater use, comprising combining a curable polymer resin with a plurality of discrete insulation bodies each comprising a core of foamed material and an outer structural plastics layer, so that the bodies are embedded in the resin, and curing the polymer resin, wherein the materials and the manufacturing conditions are such that temperatures within the bodies during manufacture are not sufficient to destroy the structure of the foamed cores.

By ensuring that the foamed cores are preserved, thermal insulation properties of the material are dramatically improved.

In accordance with a second aspect of the present invention, there is a thermal insulation material comprising a matrix of cured polymer material in which are embedded a plurality of insulation bodies comprising an outer structural plastics layer and a core of foamed material.

Specific embodiments of the present invention will now be described, by way of example only, with reference to the accompanying drawings in which:—

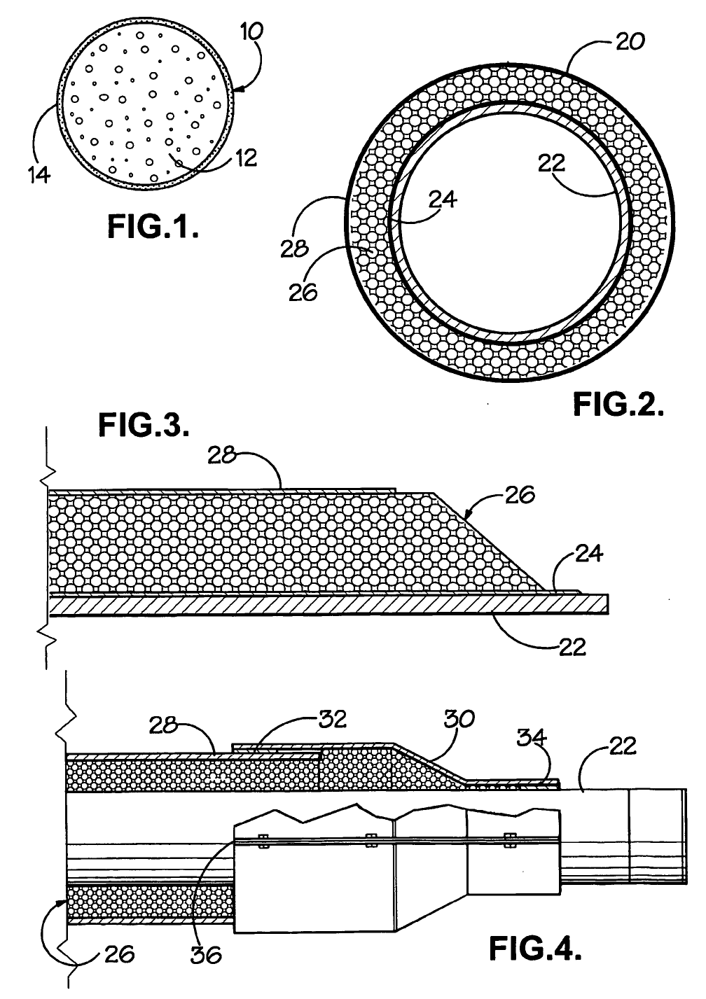

FIG. 1 is a section through a macrosphere for use in embodiments of the present invention;

FIG. 2 is a section in a radial plane through a structure comprising a steel pipe with an insulating sheath embodying the present invention;

FIG. 3 is a section through a wall of the pipe and the adjacent cladding, taken in an axial plane; and

FIG. 4 is a diagramatic representation of a similar cladding during fabrication.

The macrosphere 10 illustrated in FIG. 1 comprises an expanded polystyrene core 12, which has low density and good thermal insulation properties, and an outer plastics layer 14 which has good structural strength and in particular is resistant to crushing when subject to pressure. To manufacture the macrospheres a number of un-coated expanded polystyrene balls are tumbled along with a quantity of plastics resin. In the present embodiment the chosen plastics is a thermosetting material, more specifically an epoxy, although other plastics resins could be employed. The outer layer 14 incorporates fibre reinforcement and is built up in a multi-stage process. At each stage a quantity of plastics resin and/or finely chopped fibre reinforcement is added and tumbled to coat the spheres. The fibre reinforcement adheres to the resin and is thus incorporated into the structure of the macrospheres' outer layer 14. The present embodiment uses glass fibre reinforcement but other suitable fibre materials include carbon fibre and Wollastonite. In the present embodiment the macrospheres are approximately 10 mm in diameter but this dimension may be adjusted according to the application. A dimension in excess of 5 mm is typical. Dimensions less than 50 mm are preferred. The spherical shape is advantageous for its resistance to collapse under pressure but other shapes could conceivably be used.

The macrospheres 10 are set in a body or matrix of syntactic foam seen at 20 in FIG. 3 and comprising curable polymeric material with an admixture of microspheres 10. The polymeric material chosen in this embodiment is an elastomer, specifically polyurethane, and provides excellent water and temperature resistance, flexibility, strength and toughness. The microspheres are hollow glass items chosen in preference to the polymer spheres used in certain syntactic foams for their superior resistance to compression and creep when the material is subject to hydrostatic pressure. Polymer microspheres could however be used, particularly for shallow water applications. The diameters of the microspheres used in the present embodiment are from 50 to 150 microns.

The illustrated cladding is moulded in situ upon a pipe 22 which it serves to insulate. FIGS. 2 and 3 show the structure, which comprises a fusion-bonded epoxy tie-coat 24 between the pipe's outer surface and the moulded, annular thermal insulation layer 26. An outer sheath 28 of HDPE (high density polyethylene) serves initially as the mould for the insulation layer 26 and subsequently, in service, as protection for the cladding from mechanical damage, abrasion etc. Other materials could of course be used for the sheath. The moulding process is carried out as follows.

The pipe 22 is fitted with spider structures and then drawn into the sheath 28, the spiders serving to establish the position of the pipe within the sheath. The pipe and sheath are substantially co-axial, with an annular volume between the two. An end former 30 (FIG. 4) is fitted over the end of the sheath 28 and has a tapered shape so that it can form a seal with both the sheath 28 (through a neoprene collar 32) and the pipe 22 (through a further neoprene collar 34). The end former 30 is split at 36 to allow it to be passed around the pipe and sheath after which the two sides of the split are bolted together. The spiders (not seen) are eventually incorporated into the moulded cladding and are in this instance formed of the same polymeric material used in the syntactic foam. The pipe 22 is then inclined to the horizontal (an angle of 5-20° is chosen here) and macrospheres are introduced into the annular volume between the pipe and the sheath before the upper end of the mould is sealed using a second end former (which is not seen in the drawings but is similarly formed to the first end former 30). Moderate heating may then be applied. In the present example the mould is heated to a nominal 40° C. The drawings show a regular ordering of the macrospheres but in this respect are simplified: in practice a more random ordering is achieved.

Polymer material, in resinous form, is then injected into the annular volume via ports along the length of the sheath 28 filling the interstices between the macrospheres. The polymer material used in the present embodiment, comprising polyurethane with an admixture of hollow glass microspheres, is referred to as “glass syntactic polyurethane” or GSPU. The polyurethane used in the present embodiment comprises a polyol blend, which is loaded with the microspheres, and an isocynate component. Prior to use these components are placed under a vacuum to remove any air that might otherwise contribute to void formation and then held in separate heated storage tanks. During processing they are bought together in a mix head through a pumping unit with metering system in the recommended proportions.

Once the mould is filled, the polymer material is allowed to cure and the end formers are removed before the pipe is taken from the casting station to cool on a storage rack. The cutbacks are trimmed and cleaned of any release agent transferred from the end formers. Quality control inspections are then carried out.

The combination of glass microspheres, which are for present purposes essentially immune to both elastic compression and creep, with a solid elastomeric matrix which is similarly resistant to compression, results in a cellular material with high resistance to both elastic compression and compressive creep which is thus well suited to use under high hydrostatic pressures at large depths. The use of both microspheres and macrospheres in the cladding allows for a high packing factor and low density.

Syntactic foams incorporating macrospheres are not new in themselves.

However the applicant has directed attention to the thermal properties of such materials and in particular has recognised the problem, discussed above, of collapse of the foamed cores of the macrospheres due to the elevated temperatures to which they are exposed during the moulding/curing process. The result of this collapse is that the macrospheres are, in existing products, essentially hollow and gas filled. Convection and conduction in the macrospheres consequently contribute significantly to thermal conduction through the material. The glass microspheres of the syntactic foam are also hollow but this aspect is regarded as relatively unimportant due to their smaller size.

Elevated temperatures are, in the manufacture of known materials, created due to:—

i. heat applied to promote curing;

ii. heat given off by the polymer matrix during curing typically an exothermic process; and

iii. heat applied after curing—so called “post-cure”.

Epoxy, a conventional choice for the polymer matrix material, is highly exothermic upon curing. Also it is conventional to post-cure epoxy mouldings by heating them to temperatures in the region of 140° C. The post-curing process is useful because it promotes polymer cross-linking and serves to improve physical properties including the glass transition temperature Tg, which is raised. The applicant has found that the expanded polystyrene core of the macrospheres is destroyed at temperatures of roughly 100° C., which is why conventional curing and post curing of epoxy matrixes result in destruction of the cores.

The problem is addressed in present embodiments by limiting temperatures during manufacture. This is done by:—

i. appropriate material selection. Polyurethane gives off less heat during the curing reaction than epoxy and heat build up is less—temperatures within suitable polyurethane mouldings typically reach perhaps 80° C. High temperatures are not required to initiate curing of polyurethane.

ii. dispensing with, or appropriately controlling, applied heat. The post-curing step in particular may be dispensed with altogether or may be carried out at sub-critical temperatures. The properties of polyurethane are improved by post-curing and conventionally temperatures in excess of 100° C. would be used. However it has been established in trials that post-curing at temperatures within the range tolerated by the macrosphere core can provide most of the benefits of higher-temperature post-curing. The cladding disclosed may be heated during this phase to a temperature in the region of 90-95° C.

Substantially all of the macrosphere cores are preserved by the curing and (if it is used) the post-curing process.

These measures have been shown to preserve the macrosphere cores. The effect on thermal conductivity is dramatic. Tests have been conducted in which a sample embodying the present invention is compared with a similar sample which has been heated sufficiently to destroy the cores of the macrospheres, the former being shown to have a thermal conductivity 30% lower than the latter.

1. A method of manufacturing thermal insulation for underwater use, comprising combining a curable polymer resin with a plurality of discrete insulation bodies each comprising a core of foamed material and an outer structural plastics layer, so that the bodies are embedded in the resin, and curing the polymer resin, wherein the materials and the manufacturing conditions are such that temperatures within the bodies during manufacture are not sufficient to destroy the structure of the foamed cores.

2. A method as claimed in claim 1 further comprising treatment of the cured polymer resin by application of heat to the material, wherein the heating conditions are such that temperatures reached within the insulation bodies are not sufficient to destroy the structure of the foamed cores.

3. A method as claimed in claim 1 wherein the polymer resin is mixed with microspheres.

4. A method as claimed in claim 1 wherein the cured polymer is an elastomer.

5. A method as claimed in claim 1 wherein the curable polymer comprises polyurethane.

6. A method as claimed in claim 1 which is the manufacture of an insulating cladding, wherein the mixture of the curable polymer and the insulation bodies is cured in situ upon an item to be clad.

7. A thermal insulation material comprising a matrix of cured polymer material in which are embedded a plurality of insulation bodies comprising an outer structural plastics layer and a core of foamed material.

8. A thermal insulation material as claimed in claim 7 wherein substantially all of the insulation bodies contain a core of foamed material.

9. A thermal insulation material as claimed in claim 7 wherein the cured polymer material further contains microspheres.

10. A thermal insulation material as claimed in claim 7 wherein the cured polymer material is an elastomer.

11. A thermal insulation material as claimed in claim 7 wherein the cured polymer material is polyurethane.

12. A thermal insulation material as claimed in claim 7 in which the structural plastics outer layers of the insulation bodies are fibre reinforced.

13. An insulating cladding upon an item for underwater use comprising thermal insulation material as claimed in claim 7.

14. A method of manufacturing thermal insulation substantially as herein described with reference to, and as illustrated in, the accompanying drawings.

15. A thermal insulation material substantially as herein described with reference to, and as illustrated in, the accompanying drawings.

16. An insulating cladding substantially as herein described with reference to, and as illustrated in, the accompanying drawings.
